(19) United States
(12) Patent Application Publication
(10) Pub. No.: US 2014/0041177 A1
(43) Pub. Date: Feb. 13, 2014

(54) SEAL DRIVER

(71) Applicants: Danny L. Williams, Clarinda, IL (US); Nicholas T. Miller, Osakis, MN (US)

(72) Inventors: Danny L. Williams, Clarinda, IL (US); Nicholas T. Miller, Osakis, MN (US)

(73) Assignee: Lisle Corporation, Clarinda, IA (US)

(21) Appl. No.: 13/571,707

(22) Filed: Aug. 10, 2012

(51) Int. Cl. B25B 27/02

(52) U.S. Cl. 29/275

(57) ABSTRACT

A seal installation tool includes a drive handle upon which a metal drive plate is mounted coaxially with a seal retention member. The seal retention member includes multiple elastic, radial arms and is positioned coaxially with the drive handle and drive plate. The elastic arms center and retain a seal thereon and are capable of gripping multiple sizes and shapes of seals for placement in a seal housing.

### BACKGROUND OF THE INVENTION

In a principal aspect, the present invention relates to a tool useful for the installation of seals in motor vehicles and machinery. The tool has the capability of use for installation of various sizes of seals and is thus a general purpose seal driver. It will find use with respect to transaxle seals, front hub seals of motor vehicles and in other applications in which there is no interfering stub axle. The tool is designed to have the capability of installation of seals having different constructions. It is thus a more universal seal driver tool than typical prior art seal driver tools.

Vehicle manufacturers may incorporate seals in situations where there is no axle stub. The seals generally have a circular configuration and are fitted into a housing associated with, for example, a rear axle, a front axle or a transaxle. The seals fit into the axle housing to prevent leakage of lubricant while avoiding interference with component parts of the motor vehicle.

Removal of a seal from a seal housing is often challenging and replacement of the seal is often more challenging, particularly with respect to appropriate handling and alignment of the seal. That is, the seal opening may be in a position or location which is difficult to reach thus making it difficult to position the seal in order to drive the seal into a seated position. Often it is necessary to utilize a tool such as a hammer to facilitate driving a seal into position. Thus, a seal driver should have the capability of cooperative utilization with some type of driving tool such as a hammer. Consequently, a need has developed for an improved seal drive tool which is more universal than prior known seal drive tools and which is designed to properly hold a seal in a fixed position appropriately located and centered with respect to the opening into which the seal is to be fitted.

Typical prior art seal installation tools are comprised of solid metal component parts wherein a seal is mounted on a cylindrical adapter positioned on the end of a drive handle. The size of the adapter is coordinated with the size of the seal. The seal is placed upon the adapter and driven into a seal housing. Each seal size and configuration typically requires a special adapter.

Seal drive tools including such features are marketed, for example, by Lisle Corporation, Model No. 24800, Seal Driver, Model No. 12800, Master Pneumatic Bearing Race and Seal Driver Set, Model 12600 and 12980, Bearing Race and Seal Driver, Model 59400, Pinion Bearing Race Driver, Model 56950, Pinion Shaft Seal Driver, Model 17850, Axial Seal Installer, and Model 38060, Axle Shaft Seal Installer. Nonetheless, an improved seal driver tool which incorporates additional capabilities and utility for a wide range of seal designs and sizes constitutes a desired product.

### SUMMARY OF THE INVENTION

Briefly, the present invention comprises a tool adapted for the installation of multiple sizes of seals without changing the component parts of the seal driver. Thus, a single size seal driver may be utilized in combination with multiple sizes and designs of seals to hold the seal in a desired and fixed position, to maintain the seal in that position when it is located in a seal housing and to enable further the efficient driving of the seal into the associated seal housing. The present invention comprises a tool which includes three basic parts: a drive handle, a generally cylindrical plate which is mounted coaxially on the elongate drive handle, and a seal retention member comprised of a hub with multiple elastic, radial arms. The retention member is mounted coaxially on the opposite side of the plate from the drive handle.

When positioning a seal in a seal housing, a seal in the form of a ring is initially placed against the plate with the ring opening of the seal filled over and engaged by the radial elastic arms of the seal retention member. The elastic arms are fitted into the ring opening and will center the seal on the plate and maintain it for positioning within the seal housing. When so positioned, the seal tool driver handle may be impacted to drive and seat the seal in the housing. The seal driver may then be easily retracted when the seal is snuggly inserted into the housing.

Various sizes and configurations of the multi-armed seal retention member may be utilized. Variations in the radius of the arms and their configuration and elasticity are among the aspects and features of the tool which provides additional universality and additional benefits to the tool.

Thus, it is an object of the invention to provide an improved seal installation tool comprised of three basic parts; namely, a driver, a seal mounting plate, and a seal retention member on the mounting plate on the opposite side of the plate from the driver.

A further object and aspect of the invention is to provide an inexpensive yet rugged and easy to utilize seal installation tool which is capable of holding multiple sizes, designs and configurations of seals and thus is capable of more universal use than prior seal drivers.

Another object and aspect of the invention is to provide a seal installation tool which may be disassembled and wherein the component parts thereof may be changed in order to enhance the universality of the tool.

Another object of the invention and aspect of the invention is to provide a seal installation tool which incorporates a design enabling the use of multiple sizes and configurations of handles which may be driven in order to effect the placement of a seal in an appropriate housing.

Yet a further object and aspect of the invention is to provide a driver, plate and seal retention member which facilitate access to seal housings of machinery and vehicles that otherwise would be difficult to access when effecting a repair of the mechanical device.

These and other objects, advantages and features of the invention will be set forth in a detailed description which follows.

### BRIEF DESCRIPTION OF THE DRAWING

In the detailed description of an embodiment of the invention reference will be made to the drawing comprised of the following figures:

FIG. 1 is an exploded isometric view of an embodiment of the tool of the invention;

FIG. 1a is an isometric view of an elastic material retention member and associate insert for the embodiment of FIG. 1 viewed from the opposite side of the view of FIG. 1;

FIG. 2 is a side elevation of the assembled embodiment of the tool of FIG. 1;

FIG. 3 is an end view of the embodiment of FIG. 2;

FIG. 4 is an isometric view illustrating use of the tool of FIG. 1;

FIG. 5 is an end view of the tool as depicted in FIG. 3 wherein a seal is positioned on a plate and retained on the tool;

FIG. 6 is a sectional view of the tool taken along the line 6-6 in FIGS. 5; and

FIG. 7 is a side view of the embodiment of FIG. 1 wherein an alternate length handle is attached to a plate of the tool.

### DETAILED DESCRIPTION OF EMBODIMENTS OF THE INVENTION

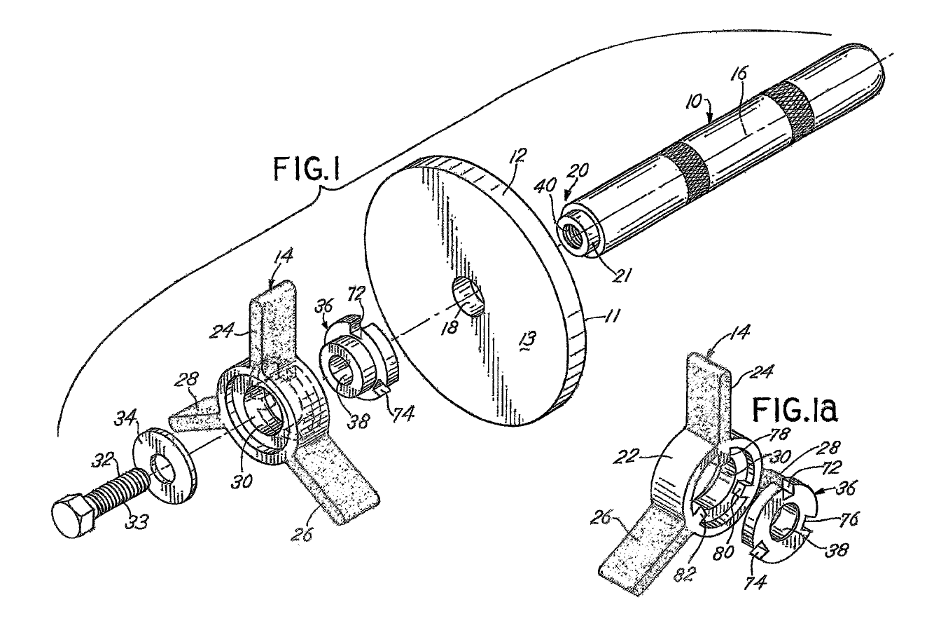

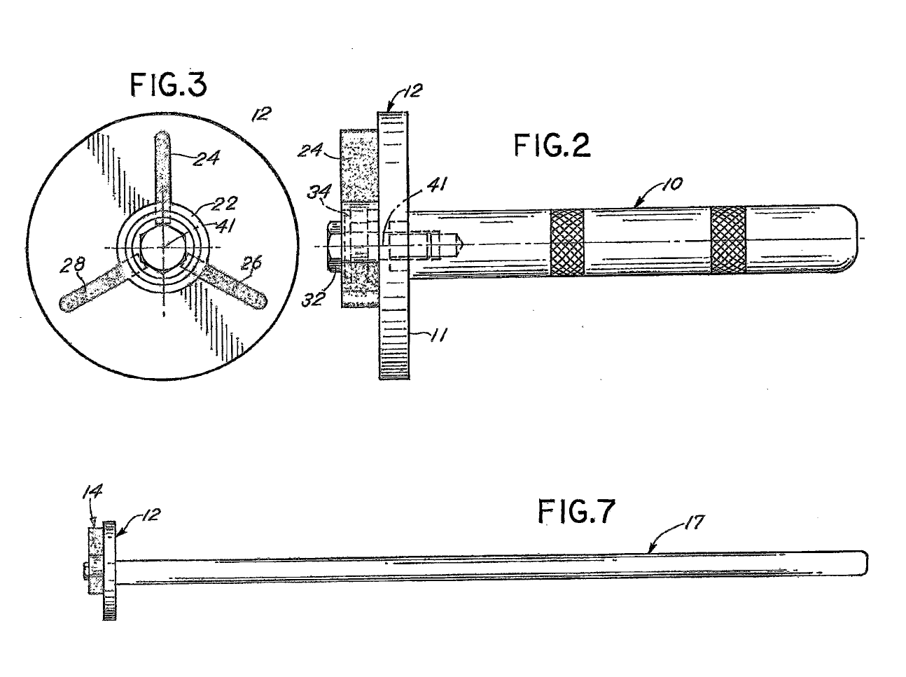

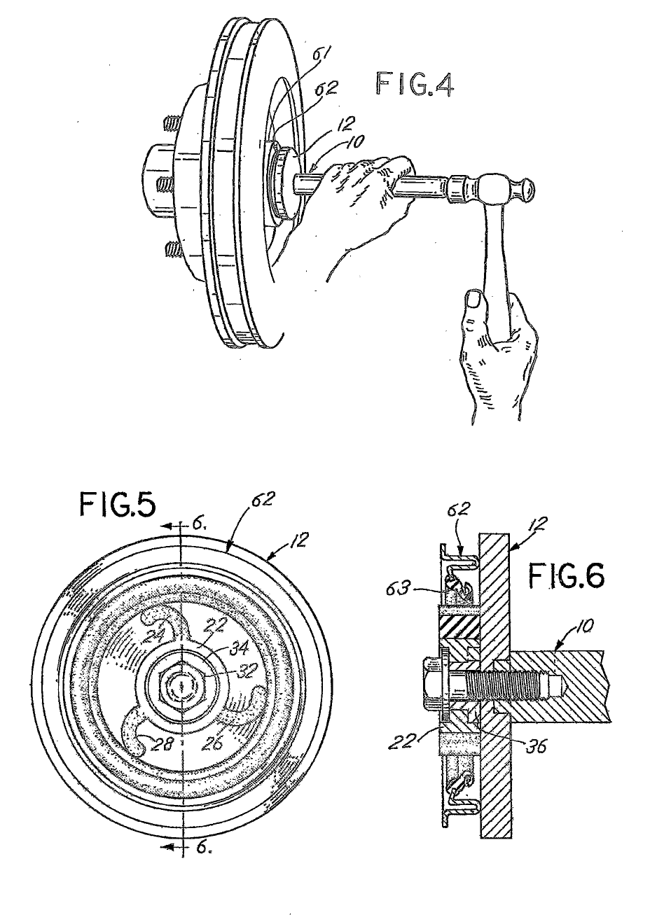

FIG. 1 is an exploded isometric view of the component parts which comprise an embodiment of the tool of the invention. FIG. 2 illustrates the assembled component parts comprising the tool embodiment in a side elevation. FIGS. 3, 5 and 6 illustrate various plan and cross sectional views of the component elements comprising the embodiment of the tool. FIG. 4 illustrates the method of use of the tool. FIG. 7 illustrates an alternate handle incorporated in the tool.

Thus referring to the figures, the tool is comprised of three basic elements: a drive handle 10, a plate 12, and a seal retention member 14. In the embodiment depicted, the drive handle 10 comprises an elongate rod having a longitudinal axis 16. The handle or rod 16 is attached to the generally flat, cylindrical plate 12 which has a center passage 18 for receipt of the drive alignment projection 21 at the end 20 of the drive handle 10 on a first side 11 of plate 12. Mounted on the opposite flat planar side 13 of plate 12 is a seal retention member 14 which includes a central hub 22 and three equally spaced substantially identical radial arms 24, 26 and 28. The seal retention member 14 is formed from an elastic material such as a unitary, molded rubber material. A typical embodiment of the seal retention member 14 is manufactured from a 50 durometer +10 molded rubber.

The hub 22 includes a central opening or passage 30 which is coaxial with the passage 18 through plate 12 and the axis 16 of the drive handle 10. The components parts are retained in an assembled condition by means of a cap screw 32 which extends through a retention washer 34 and is fitted through the passage 30 in the hub 22 and subsequently through a co-axial metal insert 36 with a central axial passage 38. The cap screw 32 is threaded into the axial threaded passage 40 in the driven end 20 of the drive handle 10. Thus in the embodiment depicted the basic component parts comprise the metal handle 10, the metal plate 12, and the seal retention member 14. The other component parts including the cap screw or fastener 32, the washer 34 and the metal insert 36 are ancillary but are considered very beneficial for the tool and for its utility use and versatility.

Referring to the various elements the drive handle 10 is typically an elongate, straight drive rod and may be of a desired length. Because the handle 10 and the other components are fastened together by virtue of the cap screw 32, the tool design enables substitution of a handle of a desired size and shape. FIG. 7 illustrates incorporation of a long drive handle 17 in contrast to drive handle 10.

The drive plate 12 preferably is in the form of a uniform thickness, cylindrical metal plate having a centerline axis 41 coaxial with the axis 16. The plate 12, and more particularly the passage 18, receives the alignment projection 21 of the handle 10. The outer diameter or dimension of the plate 12 is an important aspect of the invention and typically is at least almost or substantially equal to or greater than the maximum diameter of a seal mounted retained thereon by the seal retention member 14. As a consequence the radius of the plate 12 is typically greater than the radial extent of the arms 24, 26 and 28 and also is typically adequate to support a seal mounted on the plate 12 and retained by the arms 24, 26 and 28. This dimensional characteristic is illustrated, for example, in FIG. 5. Also, plate 12 is uniformly thick to facilitate placement of a seal in a seal housing.

The seal retention member 14 is typically formed with three arms 24, 26, 28 which are substantially identical. However, the arms may vary in design. The functionality of the arms is to maintain a seal 62 mounted and centered on the plate 12 so that when a mechanic is utilizing the tool, the mechanic can be assured that the seal is properly centered for placement in a seal opening. Thus, the design of the seal retention member 14 may be varied in order to accomplish this objective by variations from an identical form of the arms of 24, 26 and 28. Molding seal retention member 14 as a single element, however, insures the functionality, particularly when the material is an elastic material having uniform elastic characteristics. However, the elastic arms 24, 26, 28 may be attached to and extend radially from a solid hub as an alternate construction.

Further, the number of arms of seal retention member 14 may be varied. Nonetheless, in most instances, at least three arms are considered appropriate. The arms 24, 26, 28 are preferably identical to ensure that the uniform elastic properties of the arms 24, 26, 28 and the response of those elastic properties to placement of a seal onto plate 12 tend to ensure centering of a seal properly on the drive plate 12. However, the arms 24, 26, 28 may be of different design to achieve further aspects or features.

The use of a cap screw 32 and a washer 34 to maintain the seal retention member 14 in position is facilitated by a counterbore section 70 in the face of the hub 22. In order to further facilitate the maintenance of the seal retention member 14 in a coaxial position, insert 36 includes a series of three slots 72, 74, 76 arranged equally spaced around the rim of the insert 36. These slots 72, 74 and 76 receive projections 78, 80, 82 molded into the hub 22. Thus the insert 36, which includes the throughpassage 38 for receipt of the threaded shaft 33 of the cap screw 32, will facilitate the maintenance of the seal retention member 14 coaxially aligned with the other component parts of the tool.

Variations of the component parts include substitution of the drive handle 10. Various shapes and lengths may be utilized depending upon the desire of the mechanic. The seal retention member 14 may be variable in size and dimension depending upon the seals with which the tool is to be used. In that regard, variance of the seal retention member 14 may also dictate the necessity to change the size of the drive plate 12 to ensure appropriate compatibility with respect to a seal that is to be positioned by means of the tool.

A single sized seal retention member 14 will typically be useful for positioning and insertion of multiple designs and sizes of seals. Nonetheless changes in the size of the various components may be effected to accommodate a wider range of seals. A benefit of the use of a molded rubber type material or elastic material is that it can be easily replaced if it deteriorates. Further, such a member 14 can be trimmed using a cutting tool such, as a scissors, to accommodate seals of various size, dimension and configuration.

Keeping a seal centered is particularly important when inserting the seal for a transaxle or the like. That is, such seals are used on transaxles, front hubs and for other automotive and machinery applications. With these particular applications, maintaining the seal centered within the seal opening is especially important and the tool of the present invention provides an excellent means of guaranteeing that a seal will be maintained in position and adequately and easily driven into place. Additionally, the plate 12 may be magnetized or include magnets for holding of a partially metal seal in position. The combination of a magnetized or partially magnetized plate 12 with a seal retention member 14 can provide additional means for maintaining alignment of the seal in an appropriate manner during use of the tool. In the embodiment, the plate 12 is not magnetized in whole or part.

Three arms 24, 26, 28 are disclosed for use with respect to the tool of the present invention. However, this is not necessarily a limiting aspect of the invention. Depending upon the size of the seals, the structure of the seals and other factors, the number of arms 24, 26, 28 and their structure and configuration may be altered. Further, in such circumstances it may be appropriate to make the arms 24, 26, 28 distinct in configuration or construction from one another in order to accommodate seals having particular applications. Another benefit of the construction of the present invention is associated with the utilization of the elastic material for the member 14. Thus seals which include spring members 63 in FIG. 6 on the internal rim of the seal 62 are held in position by member 14 so that they will not disengage from the seal 62. That is, seals having a spring member 63 along the inner diameter of the seal are typically engaged by the elastic arms and thus prevent the spring from detachment from the seal 62 and otherwise facilitates the placement of the seal 62 in a seal opening of a motor vehicle transaxle, for example. The use of the elastic arms 24, 26, 28 thus provides multiple functions with respect to a variety of seal designs.

FIG. 4 illustrates use of the tool. Thus, a seal 62 is fitted over elastic arms 24, 26, 28 against plate 12 as shown in FIGS. 5 and 6. The plate 12 is then positioned over the seal housing 61 and driven by a hammer impacting handle 10. Once the seal 62 is seated, the member 14 and plate 12 are manually withdrawn and the housing cover placed on housing 61.

Various embodiments of the invention have been disclosed and variations suggested. The invention, however, is to be limited only by the following claims and equivalents thereof.

What is claimed is:

1. A seal installation tool comprising:
a) a drive handle including an outer drive end and an inner driven end;
b) a drive plate, said plate including a generally planar drive surface for mounting a seal, and further including a center passage for receipt of said inner driven end of said drive handle; and
c) a seal retention member for engaging and retaining a seal, said retention member including a central hub defining a center axis with multiple, radially projecting, flexible arms projecting from the hub axis and juxtaposed to the planar drive surface, said central hub mounted on said drive plate coaxially with said center passage.

2. The tool of claim 1 wherein said plate comprises a cylindrical plate with the center passage coaxial with the axis of revolution of said plate.

3. The tool of claim 1 further including a fastener for mounting said retention member on said drive plate.

4. The tool of claim 1 wherein said retention member includes at least three substantially identical arms substantially equally spaced from each other and extend equal radially from the axis.

5. The tool of claim 1 wherein said seal retention member comprises a unitary elastic material member.

6. The tool of claim 5 wherein said hub includes a passage coaxial with said center passage of said drive plate, and further including a coaxial fastener attaching said hub on said drive plate.

7. The tool of claim 6 further including an insert coaxially mounted intermediate the drive plate and said hub.

8. The tool of claim 7 wherein said insert washer includes interlocking elements engaging said hub.

9. The tool of claim 3 wherein said fastener comprises a cap screw coaxially through said hub, and wherein said retention member is a unitary element which is comprised of said hub and at least three equally spaced, identical arms.

10. The tool of claim 9 further including an insert with a central passage and equally spaced radial slots from the passage, said hub including a central passage and radially projecting engagement members interlocking with the insert slots.

11. The tool of claim 10 wherein said drive handle comprises an axially aligned rod member and said drive plate center passage, said fastener, said hub, and said insert central passage are coaxial.

12. The tool of claim 1 wherein in each radial arm is substantially identical.

13. The tool of claim 1 wherein said radial arms are an elastic material having durometer measurement of 50±10.

14. The tool of claim 10 wherein the hub includes three substantially identical arms.
